(19) United States
(12) Patent Application Publication
(10) Pub. No.: US 2005/0195952 A1
(43) Pub. Date: Sep. 8, 2005

(54) Telephone having ring stopping function

(76) Inventors: John C. Dyer, Evendale, OH (US); Roddy McKee Bullock, Milford, OH (US)

Correspondence Address: Roddy M. Bullock, 936 Hidden Ridge, Milford, OH, 45150, US

(21) Appl. No.: 11/065,557

(22) Filed: Feb. 25, 2005

Related U.S. Application Data
(60) Provisional application No. 60/548,087, filed on Feb. 25, 2004.

(51) Int. Cl. H04M 3/42; H04M 1/64

(52) U.S. Cl. 379/201.01; 379/82

(57) ABSTRACT

A telephone comprising means for stopping the audible ringing due to an incoming call without answering or hanging up on the incoming call is disclosed. The telephone can be a portable telephone such as a cellular telephone, a cordless telephone, or a satellite telephone. The means for stopping the audible ringing includes motion sensor means and depressible portion means.

### CROSS REFERENCE TO RELATED APPLICATIONS

This application claims the benefit of U.S. Provisional Application No. 60/548,087, filed Feb. 25, 2004.

### FIELD OF THE INVENTION

The current invention relates to the field of telephones, and more specifically to portable telephones, including cordless and cellular telephones.

### BACKGROUND OF THE INVENTION

Telephones, including portable telephones, are well known in the art. Portable telephones include telephones which are at least in part cordless or wireless. One example of a portable telephone is a so-called cordless telephone which generally includes a wired-in base unit and a cordless handset. Wireless telephones also include cellular telephones and satellite telephones as are well known in the art. Portable telephones can also be mobile telephones.

A problem with portable telephones is that their ease of portability makes them susceptible to being in situations or contexts in which the ringing associated with the signaling of an incoming call can be disruptive to the surroundings and embarrassing to the user. For example, we have all experienced the ringing of a cell phone during a church service, a play, an opera, or other setting in which the ringing was both distracting and annoying. Moreover, the person whose phone is ringing often feels compelled to answer the phone both to stop the ringing, and apparently, to speak to the one whose call cannot wait. Therefore, in addition to the ringing being an interruption in the first place, the person who is attempting to quickly leave while speaking on the phone is an additional distraction.

With current telephone technology, the surprised phone user in such a situation has only two options. First, he or she can simply push the “end” button or similar button that not only stops the ringing, but hangs up on the caller, who then hears a dial tone. Second, the user can answer the phone and attempt to speak quietly while leaving the setting, such as a church service. Both options have significant drawbacks. With the first, the caller is left without getting through to the recipient of the call; with the second, the setting is severely interrupted, to the embarrassment of the phone user, and the irritation of those around.

Accordingly, there is a continuing unaddressed need for another option that reduces both the embarrassment and the annoyance of phone calls in inappropriate contexts.

### SUMMARY OF THE INVENTION

A telephone comprising means for stopping the audible ringing due to an incoming call without answering or hanging up on the incoming call is disclosed. The telephone can be a portable telephone such as a cellular telephone, a cordless telephone, or a satellite telephone. The means for stopping the audible ringing includes motion sensor means and depressible portion means.

### DETAILED DESCRIPTION OF THE INVENTION

The telephone of the present invention has associated with it an apparatus, device, or component that permits the user to stop the audible ringing used to signal an incoming call, without either hanging up on the caller, or immediately answering the call. This is referred to herein as facilitating a “stop ring” function of the telephone. Although disclosed in the context of a telephone as the term telephone is ordinarily used, it is recognized that the invention could be adapted to work with any device that has similar functions, such as personal electronic schedulers, often termed PDA's, such as Palm PILOT® systems, and the like.

As used herein, the term the term telephone means a telephone intended to be portable and includes mobile, cordless, cellular and satellite telephones.

As used herein, cordless telephones refers to telephones having a base unit and a portable, cordless handset.

As used herein, the term cellular telephone refers to wireless telephones using cellular telephone technology, sometimes referred to as mobile phones.

As used herein, the term satellite telephone refers to wireless telephones using satellite telephone technology.

In all cases of cordless, cellular, and satellite telephones, as used herein, the ordinary meaning of the each word is intended. That is, the terms encompass at least what is understood by the ordinary meaning of the terms.

As used herein the term “associated with” in respect to the apparatus, device or component of the telephone of the invention means the subject apparatus, device, or component is in operative relationship to the telephone, and, in general will be in or on the telephone and electrically connected thereto. “In operative relationship” means that it is connected or otherwise disposed to provide the necessary function, such as by being connected by any necessary or desired electric or electronic circuitry.

As used herein the term “audible ringing” refers to the audible sound emitted by a receiving telephone to signal an incoming call. Therefore, the term encompasses rings and other sounds, including any of various sounds, beeps, tones, melodies, buzzes, and the like that can be used to signal incoming calls. The term does not refer to the sound the caller hears in the calling telephone with respect to the telephone being called.

In one embodiment, the telephone of the present invention includes pressure-sensitive means for stopping the audible ringing due to an incoming call without answering the call or hanging up on the caller. As described below, the pressure-sensitive means can be a depressible portion of the telephone, and can include a key or button on the telephone keypad or in or on another portion of the telephone, referred to herein as a “stop ring button.” As used herein “key” and “button” are used interchangeably and refer to the user-depressible portions of a telephone, for example the numbered portions on a typical keypad. A typical cellular telephone, for example, has buttons for each of the numbers 0-9, as well as a button to initiate and end a call. The button to initiate the call can be designated “send,” for example, and can be used both to initiate a call out, and to answer a call in. A button utilized in the present invention can be a currently-existing button with the added feature of stopping the audible ringing. The pressure-sensitive means can also include a touch-sensitive pad, a pressure-sensitive pad, or equivalents thereof.

In one embodiment, a telephone of the present invention can have a pressure-sensitive pad sensor. Whether a pressure sensitive pad or a depressible button, when depressed, the stop ring means stops the audible ringing of the telephone but does not answer the telephone or hang up on the caller. The caller may simply hear the phone continue to ring. Once the user depresses the stop ring means to stop the ringing, the person being called can quietly move to a location more conducive to answering the telephone, at which time the user can answer the phone in the conventional manner.

An existing button on a telephone, for example on the keypad thereof, can be utilized as the stop ring button in the present invention in a variety of ways. For example, the button can simply be depressed and released to stop the audible ringing. Once the user is ready to answer the incoming call, the same button can be depressed again, or another button can be depressed, to answer the call.

In another embodiment, a button used as the stop ring button on the telephone keypad can be depressed and held depressed until the user is ready to answer the call. Thus, upon the audible ring of an incoming call, the user can depress a button to stop the ringing without answering the phone or hanging up on the caller. Then, once the user is in a location conducive to answering, he or she can then release the depressed button, which answers the phone.

In the embodiment in which the button is depressed and held depressed until release and answer, the function can be incorporated into the existing button used for answering, typically marked “send” or the like on cellular telephones and usually indicated by green color. Therefore, if the user simply pushes and releases the button in the usual manner, the phone is simply answered in the usual manner. However, if the user pushes the button and holds it, the audible ringing is stopped, but the phone is not answered until release of the button.

Because the correct button on a typical telephone keypad may be difficult to locate in a hurry, especially when surprised by the audible ringing, in a more preferred embodiment, the stop ring button can be located off the keypad area and onto a more conspicuous portion of the telephone, such as the top, bottom, or back thereof. Moreover, the button need not be an actual “button” but can be a pressure pad, a pressure point, a touch pad, or another sensor such as squeeze-activated sensors, that, when activated, operates to stop the audible ring of a telephone without answering or hanging up on the caller. For example, the stop ring function can incorporate a touch pad using technology known for touch pads on computers, PDA's, and the like. Therefore, one or two taps on the touch pad can activate the stop ring function, for example.

In many cases unexpected and disturbing audible rings emanate from a telephone in a pocket, purse, or other immediately inaccessible place. Thus, in one embodiment, rather than stop the audible ringing by direct contact with of a portion of the telephone, the stop ring function can be performed by a motion sensor upon sensing sufficient motion. For example, in one embodiment a motion sensor can be operatively associated with a telephone of the present invention such that upon receiving a telephone call and the audible ring associated therewith, the user can hit, shake, jar, or otherwise induce sudden motion to the telephone to effect the stop ring function. Then the user can calmly leave the area and answer the telephone in the typical manner in a more conducive environment.

The motion sensor can be a motion transducer such as an accelerometer or a gyroscope, or equivalents thereof. The motion transducer of the present invention may be, for example, a one-axis, two-axis, or three-axis accelerometer, a gyroscope, and/or an attitude sensor as are known. The motion transducer can be associated with the telephone by means known in the art, such as by electrical circuitry, to effect the stop ring function.

Although not necessary for the present invention, in one embodiment, the telephone may also include a user interface so that the user can select certain motions to “teach” the telephone selected motions for the stop ring function. The motion transducer can monitor the motion of the device, and when it detects that a stop ring motion has occurred (either as “learned” through programming via the user interface, or as pre-set by the set parameters of the motion transducer), the motion transducer then signals the telephone via data transmission techniques known in the art to stop the ringing of the telephone. The telephone can include circuitry and/or software to effect the stop ringing function of the telephone. However, to be clear, the stop ring function need not be user-programmed, but can be preset by the design of the motion transducer and related circuitry and software. Of course, in some embodiments, there can be a user-configurable “over ride” function that can, in effect, turn off the stop ring function either temporarily or permanently.

If a user interface is included in order to “teach” the telephone a motion sequence, the technique, device and method disclosed in WO 02/31788, published 18 Apr. 2002 can be used, which publication is hereby incorporated by reference herein for such teaching.

Accelerometers suitable for use in the present invention can be any of known accelerometers, although, of course, it is preferred that they be of relatively small size so as to be incorporated in small-size telephones. Accelerometers can be used to perform the stop ring function, such as by detecting the acceleration associated with a sudden shake, and thereafter the telephone's usual method of answering the call can be utilized.

The telephone of the present invention can have a timed re-ring function. That is, after a certain amount of time after the stop ring function has been performed, if the telephone is not answered, the ringing can continue. Therefore, if the telephone is inadvertently shaken right as an incoming call is received such that the person being called does not hear, the phone will ring again to so alert the person. Or, in certain instances, a person being called might get distracted and forget to answer the call. Therefore, by way of example, if a call comes in and the stop ring function is activated, either by direct pressure of a button, or by sudden movement sensed by an accelerometer, after 1 minute the ringing can be re-initiated. Of course, the re-ringing can be stopped by the stop ring function as well.

Accelerometers suitable for use in telephones can be Micro Electric Mechanical Systems (MEMS) integrated circuits (IC). Accelerometers can be obtained, for example, from Memsic as the MXA2500U MEMS accelerometer/sensor. The accelerometer can measure dynamic and static acceleration with a full-scale range of +/−1 g and a sensitivity of 500 mV/g at 25 degrees C. The accelerometer can be engineered for cellular telephones, but can be used in any portable telephone. It can deliver better than 1 mg resolution, a 50,000 g shock survival rating, 25 Hz bandwidth, and a 2.7 to 5.2 V operating supply. It can be delivered in a 5×5×2-mm package.

The accelerometer for a telephone of the present invention can be preset within any of various engineered parameters for various levels of sensitivity to shock sufficient to activate the stop ring function. In one embodiment, the accelerometer can be preset with various levels of sensitivity, such that the user can select a desired sensitivity to activate the stop ring function. Lower levels of sensitivity can require relatively low acceleration, and higher levels of sensitive can require relatively higher accelerations to activate the stop ringing functions.

Another accelerometer suitable for use in telephones of the present invention are MEMS devices available from Very Small Technologies, Inc. MEMS devices can be C-MOS-based MEMS. Very Small Technologies makes accelerometers of suitable sizes for use in portable telephones.

The accelerometer of the present invention can integrate a sensor with signal processing circuits, including mixed signal processing circuits, monolithically onto a single chip that can be manufactured on a standard, sub-micron CMOS process, providing for long-term reliability and performance at relatively low cost.

In operation, a telephone of the present invention can have an accelerometer operatively associated therewith, such that upon hearing an audible ring, the user can simply hit, jar, shake, or vibrate the telephone with sufficient motion to cause the accelerometer to process a signal to stop the audible ringing. Motion “sufficient” can be varied by the telephone designer and preset (optionally with variable settings such as “light” “medium” or “hard”), or, as indicated above, can be user-defined by a programmable technique.

In like manner, the motion transducer can be a gyroscope that is activated upon sufficient movement and associated with appropriate circuitry or software to effect the stop ring function.

In one embodiment, the telephone of the present invention can have both a pressure-activated stop ring function, and a motion-activated stop ring function. In this embodiment, the stop ring functions can act in parallel, whichever one is activated first, performs the function of stopping the ring.

Although in a preferred embodiment the motion transducer is incorporated within the telephone, it can be provided in a separate device, with appropriate communication between the motion transducer and the telephone. For example, the motion transducer may be provided as a separate external element which communicates via a corded, infrared, radio frequency or other communication type with the telephone.

The telephone of the present invention can have a message function that lets the caller know that the telephone will be answered in due course. For example, in operation upon audible ringing, the user shakes the phone, and/or depresses a depressible portion, whichever, or both are provided for, and the ringing stops. At that time the caller can either continue to hear ringing, or can get a message that says, for example, “I will answer your call in about one minute,” or “please wait while I leave a meeting. I will answer your call momentarily,” or the like.

While particular embodiments of the invention have been described, those skilled in the art will recognized that various modifications can be made to the without departing from the scope of the present invention. For example, any of known features on mobile and cellular telephones, such as internet access, GPS capability, digital cameras, lighted keypads, caller ID, antenna configurations, system configurations, and the like, can be utilized with the present invention. Therefore, the following patents and publications are hereby incorporated herein by reference for all their respective enabling teachings for various features and benefits known in the field of portable, mobile, and/or cellular telephones, each of which are considered within the scope of the present invention: U.S. Pat. No. 6,697,636, entitled Radio Telephone Buzzer; WO04008725A1, entitled Flexible Cover For A Mobile Telephone; U.S. Pat. No. 6,681,124, entitled Telephone Handset Having A Touch Input Button On The Rear Surface Of The Handset; U.S. Pat. No. 6,677,541, entitled Keyboard And Key And Telephone Apparatus With Such A Keyboard; U.S. Pat. No. 6,671,370, entitled Method And Apparatus Enabling A Calling Telephone Handset To Choose A Ringing Indication(s) To Be Played And/Or Shown At A Receiving Telephone Handset; U.S. Pat. No. 6,647,274, entitled Radio Telephone With Initial Delay Before Performing A Predetermined Function; U.S. Pat. No. 6,647,249, entitled Radio Telephone; WO03088629A1, entitled Portable, entitled Foldable Electronic Device Equipped With Telephone Functions And Camera Functions; U.S. Pat. No. 6,631,264, entitled Radio Telephones And Methods Of Operation; U.S. Pat. No. 6,625,452, entitled Radio Telephone System; WO03065705A1, entitled A Method For Providing A Signal To Be Output By A Telephone For Indicating An Incoming Call; WO03021913A2, entitled Telephone Set Having A Touch Pad Device; WO03019913A1, entitled A Method Of Operating An Electronic Device; U.S. Pat. No. 6,519,241, entitled Mobile Telephone For Internet-Applications; U.S. Pat. No. 6,480,725, entitled Telephone; U.S. Pat. No. 6,463,278, entitled Telephone Automatic Mode Selection; U.S. Pat. No. 6,463,262, entitled Radio Telephone; U.S. Pat. No. 6,453,179, entitled Radio Telephone System; U.S. Pat. No. 6,380,897, entitled Portable Radio Telephone; U.S. Pat. No. 6,377,820, entitled Radio Telephone; U.S. Pat. No. 6,363,259, entitled User Interface For A Radio Telephone; U.S. Pat. No. 6,349,212, entitled Cordless Telephone Arrangement; U.S. Pat. No. 6,314,166, entitled Method For Dialling A Telephone Number By Voice Commands And A Telecommunication Terminal Controlled By Voice Commands; U.S. Pat. No. 6,310,867, entitled Portable Radio Telephone And Methods Of Operation; U.S. Pat. No. 6,298,225, entitled Radio Telephones And Method Of Operation; U.S. Pat. No. 6,272,361, entitled Radio Telephone; U.S. Pat. No. 6,195,573, entitled Radio Telephone Receiver With Quick Quiescent Mode; U.S. Pat. No. 6,151,485, entitled Radio Telephone; U.S. Pat. No. 6,122,519, entitled Radio Telephones And Methods Of Operation; U.S. Pat. No. 6,058,185, entitled Portable Telephones; U.S. Pat. No. 6,055,439, entitled Mobile Telephone User Interface; U.S. Pat. No. 6,021,193, entitled Telephone; WO03065694A1, entitled Telephone Handset Unit; WO03056710A1, entitled Cellular Telephone With Simultaneous Cdma And Tdma Communications; U.S. Pat. No. 6,535,127, entitled Panic Alert For Cellular Telephone; U.S. Pat. No. 6,510,142, entitled Method And Apparatus For Reduced Reversed Traffic In A Cellular Telephone System; WO02096075A1, entitled Telephone Apparatus And A Communication Method Using Such Apparatus; U.S. Pat. No. 6,430,405, entitled Method For Retrieval Of Stored Telephone Numbers In A Radio Communication Device; U.S. Pat. No. 6,404,764, entitled Voice Over Internet Protocol Telephone System And Method; U.S. Pat. No. 6,351,653, entitled Cellular Telephone With Simultaneous Radio And Cellular Communications; WO0162028A1, entitled Mobile Telephone Allowing For Reduced Battery Consumption During Idle Mode; U.S. Pat. No. 6,240,303, entitled Voice Recognition Button For Mobile Telephones; U.S. Pat. No. 6,141,546, entitled Mobile Telephone Systems; U.S. Pat. No. 6,137,883, entitled Telephone Set Having A Microphone For Receiving An Acoustic Signal Via Keypad; U.S. Pat. No. 6,064,894, entitled Portable Radio Telephone Having Improved Speaker And Housing Assembly For Handsfree And Private Operation; WO0019744A1, entitled Emergency Telephone System Ring Suppressor Apparatus And Method; U.S. Pat. No. 6,044,153, entitled Hand Adaptive Telephone; U.S. Pat. No. 6,034,921, entitled Method, Entitled Apparatus, Entitled Pager, Entitled And Cellular Telephone For Accessing Information From A Memory Unit Utilizing A Sequential Select Unit; U.S. Pat. No. 6,078,826, entitled Mobile Telephone Power Savings Method And Apparatus Responsive To Mobile Telephone Location; U.S. Pat. No. 6,611,682, entitled Mobile Telephone Apparatus And Method For Call Divert Service; U.S. Pat. No. 6,600,937, entitled Vibrator Assembly For Mobile Telephone; U.S. Pat. No. 6,542,758, entitled Distributed Radio Telephone For Use In A Vehicle; U.S. Pat. No. 6,493,542, entitled Arrangement At A Mobile Telephone; U.S. Pat. No. 6,445,429, entitled Method For Assembling A Liquid Crystal Display Panel In A Mobile Telephone; U.S. Pat. No. 6,442,377, entitled Radio Telephone With High Antenna Efficiency; U.S. Pat. No. 6,424,844, entitled Portable Telephone; U.S. Pat. No. 6,421,547, entitled Arrangement At A Mobile Telephone; U.S. Pat. No. 6,418,319, entitled Method Of Directing A Call To A Mobile Telephone In A Dual Mode Cellular-Satellite Communications Network; U.S. Pat. No. 6,377,827, entitled Mobile Telephone Having A Folding Antenna; U.S. Pat. No. 6,374,088, entitled Arrangement At A Mobile Telephone; U.S. Pat. No. 6,343,214, entitled Mobile Telephones; U.S. Pat. No. 6,330,461, entitled Mobile Telephone Apparatus; U.S. Pat. No. 6,292,674, entitled One-Handed Control For Wireless Telephone; U.S. Pat. No. 6,263,079, entitled Telephone With Means For Enhancing The Low-Frequency Response; WO147306A1, entitled Cordless Telephone System; U.S. Pat. No. 6,223,029, entitled Combined Mobile Telephone And Remote Control Terminal; WO0128204A1, entitled Telephone Capable Of Playing Music; U.S. Pat. No. 6,215,993, entitled Caller ID Preview For Mobile Telephones; WO0108387A1, entitled Distributed Radio Telephone For Use In A Vehicle; U.S. Pat. No. 6,157,620, entitled Enhanced Radio Telephone For Use In Internet Telephony; WO0065805A, entitled Miniature Piezo-Ceramic Vibrators For Wireless Communication Devices And Cellular Telephones; U.S. Pat. No. 6,141,570, entitled System And Method For Conserving Battery Energy In A Wireless Telephone With An Integral Global Positioning System; WO0051317A 1, entitled Caller Id Preview For Mobile Telephones; U.S. Pat. No. 6,072,868, entitled Telephone With Touch-Any-Key Dialing Mode; U.S. Pat. No. 6,070,076, entitled Identification Of Mobile Calls Within A Mobile Telephone System; WO0021265A1, entitled Cellular Telephone With Sequentially Lighted Keypad; WO0007344A1, entitled Telephone Apparatus With Volume Control; WO0007343A1, entitled Telephone With Touch-Any-Key Speed Dialing Mode; U.S. Pat. No. 6,023,620, entitled Method For Downloading Control Software To A Cellular Telephone; and U.S. Pat. No. 6,021,325, entitled Mobile Telephone Having Continuous Recording Capability. It is intended to cover, in the claims, all such modifications that are within the scope of this invention.

1. A telephone comprising means for stopping the audible ringing due to an incoming call without answering or hanging up on the incoming call, and wherein a caller hears a message while waiting for the call to be answered.

2. The telephone of claim 1, wherein said telephone is a cellular telephone.

3. The telephone of claim 1, wherein said telephone comprises a cordless handset.

4. The telephone of claim 1, wherein said telephone is a satellite phone.

5. The telephone of claim 1, wherein said means comprises a depressible portion.

6. The telephone of claim 5, wherein said depressible portion is one of a plurality of buttons of a keypad portion of a telephone.

7. The telephone of claim 5, wherein said depressible portion is a pressure-sensitive pad.

8. The telephone of claim 5, wherein said depressible portion can be released and wherein the depressible portion stops the audible ringing while depressed, and permits ringing to continue when released.

9. The telephone of claim 5, wherein said depressible portion is a button designated for answering the telephone in the typical manner.

10. A telephone comprising means for stopping the audible ringing due to an incoming call without answering or hanging up on the incoming call, wherein said means for stopping the audible ringing comprises a motion transducer.

11. The telephone of claim 10, wherein the motion transducer comprises an accelerometer.

12. The telephone of claim 10, wherein the motion transducer comprises a gyroscope.

13. The telephone of claim 12, wherein said accelerometer is a MEMS accelerometer.

14. A method for answering a telephone having an audible ring to indicate an incoming call, the method comprising:
a. providing a depressible portion on a portion of the telephone;
b. depressing said depressible portion upon receipt of incoming call as indicated by an audible ring;
c. holding said depressible portion in a depressed condition to stop the audible ringing without answering the telephone call;
d. releasing the depressible portion to answer the telephone call.

15. The method of claim 14, wherein said depressible portion is a keypad button.

16. The method of claim 14, wherein said depressible portion is depressed at least 0.5 seconds before answering.
